(19) United States
(12) Patent Application Publication
(10) Pub. No.: US 2014/0262588 A1
(43) Pub. Date: Sep. 18, 2014

(54) PASSENGER CAR AND PASSENGER CAR MODULE

(71) Applicant: THYSSENKRUPP AUTOMOTIVE SYSTEMS GMBH, Essen (DE)

(72) Inventors: Sylke Bruns, Muenchen (DE); Jan R. Kurzok, Essen (DE); Steffan Schmidt, Koeln (DE); Adrian Tropoja, Muennerstadt (DE)

(21) Appl. No.: 14/350,813

(22) PCT Filed: Oct. 10, 2012
(86) PCT No.: PCT/EP2012/070014

§ 371 Date: Apr. 10, 2014

(30) Foreign Application Priority Data
Oct. 18, 2011 (DE) 102011054580.8

(51) Int. Cl. B62D 21/11

(52) U.S. Cl. CPC B62D 21/11
USPC 180/291

(57) ABSTRACT

The invention relates to a passenger car with a chassis, an engine (3, 103) and a vehicle axle, comprising a crossmember (1) connected to the chassis and two wheels movably connected laterally via a respective connection arrangement, wherein the wheels can be moved by the engine (3, 103) via the connection arrangement, and wherein a housing (6, 106) of the engine (3, 103) forms a transverse bridge of the crossmember (1) for transmitting transverse forces. According to the invention the crossmember (1) is fixed to the chassis via the housing (6, 106) of the engine (3).

The invention relates to a passenger car with a body, according to the preamble of claim 1. The known axle is preferably the driving axle of a two-track vehicle, wherein at least one further wheel, usually at least one further axle, is provided for support on the roadway. In principle, however, the invention also relates to passenger cars that comprise a plurality of driven axles, in particular an all-wheel drive. The described design of the driven axle can then be provided, in the case of an all-wheel vehicle with two axles, on both axles or only one of the two axles.

The present invention relates specifically to passenger cars, wherein the body is intended to accommodate and protect people.

Very great demands are made on the construction of modern passenger cars. Thus, the body must be capable in the event of a collision of converting as much kinetic energy as possible into strain energy without a passenger compartment being significantly deformed. Furthermore, a high degree of rigidity, a low tendency to vibration and a high degree of operational stability are sought for the driving mode. In particular, the whole body or parts of the body should not exhibit a natural frequency that can easily be excited during the driving mode. Finally, attempts are made to enable a repair that is as straightforward as possible in the event of damage to the body.

Against the background of the described requirements, self-supporting bodies for passenger cars have been tried and tested in practice. With regard to the design and production of modern passenger cars, the body represents a module that is combined during assembly with other modules such as the front axle and the rear axle as well as the engine and the further add-on parts. In mass production, the individual modules are as a rule prefabricated and joined together one after the other in a continuous process. An engine compartment is provided in the body for the engine, into which engine compartment the engine is inserted during assembly, wherein the engine is supported on the body by means of elastically deformable engine bearings. The support by means of elastic engine bearings in the self-supporting body is expedient for enabling a certain amount of movement of the engine in the event of a sudden load change and for keeping vibrations away from the body that can have a very adverse effect on the comfort of the passenger car.

As further modules, modern passenger cars comprise a front axle and a rear axle, which in each case comprise an axle support fastened to the body and wheels attached thereto in each case by means of a steering-arm arrangement. In the case of the driven axle, the wheels are attached by means of an articulated shaft to a gear assembly, which usually comprises a step-down gear unit and a differential. Whereas the articulated shafts are provided to transmit the drive power from the engine or gears to the driving wheels, the engine and the driven vehicle axle are connected via the interposed body.

An axle design for a passenger car according to the preamble of claim 1 is known from DE 10 2004 022 242 [US20040222030 & US 2004022031]. A passenger car equipped with the described axle design comprises a body, an engine and a vehicle axle, which comprises an axle support connected to the body and, on said axle support, two wheels attached laterally in a movable manner in each case by means of a connection arrangement. The connection arrangement comprises a steering-arm arrangement, with which the wheels are movable in the vertical direction relative to a subsurface in order to enable a deflection. Moreover, the connection arrangement also comprises a tie rod arrangement, with which the steering angle of the wheels can be adjusted for the steering of the passenger car. The engine comprises a circular-cylindrical or essentially circular-cylindrical housing and bridges only a central section of the axle support. Essential further components of the axle support are components arranged on the end sides of the housing, with which components the axle support can be fastened to the body and to which the connection arrangement is fastened. In addition, there is the advantage that use can be made of lateral components adapted in their design for different vehicle platforms.

Against this background, the problem underlying the invention is to increase the stability and rigidity of the axle support.

Proceeding from a passenger car with the features described at the outset, the problem is solved according to the invention by the fact that the axle support of the engine is fastened to the body via the housing. According to the present invention, the engine is integrated, as a supporting and at least transverse force-transmitting part, into the driving axle. Whereas, in the case of a conventional passenger car, the transverse bridges of the axle support are provided solely for the provision of a stable vehicle axle, a dual function is assigned to the housing of the engine. The invention makes use of the knowledge that the housing of the engine in any case usually has to have a great stability in order to accommodate an internal combustion engine or an electrical machine as a drive for the passenger car. The stability of the housing is also used, according to the invention, to transmit at least a part of the transverse forces acting on the axle support. The described design can be used both for a driven front axle as well as for a driven rear axle. According to the invention, the housing serves not only to accommodate the engine, but also to fasten the entire axle support to the body. The present invention thus teaches that a special housing form has to be provided, which also takes account of the mechanical demands on a fastening. As a result of the housing as a solid, supporting component, a higher stability and rigidity is achieved by the one-piece embodiment. A reduction in the parts to be connected to one another overall results, so that potential weak points are also avoided. Even though the housing itself has to be produced more expensively due to the one-piece embodiment of the housing, reduced assembly outlay is also obtained overall. According to the present invention, a modular design is intentionally dispensed with in order to achieve improved mechanical properties. In motor vehicles, travel drives or actuators are possibly attached to the body by means of elastic connection elements in the form of bearings, buffers or suchlike, in order to prevent noise transmission and the transmission of vibrations and oscillations from the motorized drive to the passenger compartment of the body. According to DE 10 2004 022 242 A1, the housing of the engine is separated from the body at least by the lateral components. In contrast, the present invention teaches the direct fastening of the housing to the body, it being accepted that the transmission of noises and vibrations has to be suppressed by other measures if need be.

Proceeding from a conventional axle support with a front transverse bridge and a rear transverse bridge, at least one of the two transverse bridges can be omitted as a result of the support of the transverse forces via the housing of the engine provided according to the invention. The omission of one of two transverse bridges is particularly recommendable when a subsequent integration of an engine into the driven vehicle axle is intended as a passenger car module in the case of an existing vehicle design. The fastening of the whole axle support to the body always takes place via the housing, irrespective of whether a further transverse bridge is provided.

The present invention is particularly suitable for the integration of an electric motor, because the latter can be disposed in a compact fixed housing. Alternatively, however, the integration of an internal combustion engine into the driving axle is in principle also possible according to the inventive design, the engine block then forming the housing of the engine.

The described engine can be the sole drive motor of the passenger car or also an auxiliary motor. The described design is particularly well suited for vehicles with a hybrid drive, wherein the engine integrated into the vehicle axle is an electric motor and, depending on the circumstances, serves as an auxiliary motor or as an exclusive drive motor. In the case of hybrid vehicles, a drive exclusively by the electric motor is preferably provided in urban areas and over short distances, the internal combustion engine being switched on over long distances or at high speeds, i.e. serving as an exclusive drive source. The installation space can be minimized by the integration of the electric motor into the axle. This is advantageous especially in the case of hybrid vehicles, because further installation space is also lost for the batteries, said space instead being able to be used for luggage space or the passenger compartment. If a purely electrical drive is provided, one of the vehicle axles or both of the vehicle axles can be equipped with the integrated motor. With an electric motor, there is also the advantage that the latter can be used as a generator for energy recovery during braking. Apart from a pure electric vehicle or a hybrid vehicle, a design is also possible in which an internal combustion engine is used not for the direct drive, but for the current generation for a generator, wherein the electrical energy thus obtained is used directly for the electric motor or is temporarily stored in batteries. This technology is also referred to as “range extender technology”.

In an embodiment as an electric motor, the latter can be constituted for example as an asynchronous motor with a cage rotor or as a synchronous motor with electrical excitation or excitation by means of permanent magnets. Air andor water cooling expediently takes place. Within the scope of the invention, provision can be made such that the axle is constituted by two lateral axle sections assigned in each case to a driving wheel and the engine, wherein the housing of the engine is the sole transverse bridge between the lateral axle sections. The design of a usually frame-shaped axle support is then completely dispensed with, wherein all the transverse forces acting on the driven vehicle axle are carried away via the housing of the engine.

In a plan view of the axle, i.e. with the assembled in vehicle in view normal to the roadway, the engine is disposed along a connecting line between the two driving wheels, so that the housing of the engine, as a transverse bridge, transmits the major part of the transverse forces acting on the axle support or, if no further transverse support is present, all the transverse forces acting on the axle support.

A further simplification can be achieved if the steering-arm arrangements are supported in each case directly on the housing of the engine or on the fastening elements attached to the engine. With an embodiment of the steering-arm arrangement as a multiple steering-arm unit, the individual steering arms of the multiple steering-arm unit are therefore attached, at a plurality of points spaced apart from one another, directly to the housing of the engine.

According to the invention, the engine is intended to transmit at least in part the transverse forces acting on the axle support. On account of the stable construction of the housing, however, the latter can also be used to transmit the longitudinal forces, because the overall vehicle axle is supported via the housing of the engine on the body.

Independently of the fastening of the vehicle axle to the body, the driving wheels are usually supported by a springdamping arrangement, wherein the support can take place by means of a shock-absorbing leg directly on the body. This gives rise to the advantage that the position of the engine integrated into the axle is precisely fixed with respect to the body, apart from twisting of the body or mobility on the fastenings (for example rubber bearings).

Within the scope of the invention, the vehicle axle is usually fastened to the underside of the body, wherein the fastening can be made to bearing longitudinal supports of the body.

Irrespective of the embodiment as an internal combustion engine or an electric motor, the housing of the engine can comprise a differential and a gearbox. Whereas the differential is intended to enable a differing speed of the individual driving wheels when driving round curves, the gearbox serves to achieve a torque and a speed conversion between drive and output. All the known types of transmission are suitable, such as a double-clutch transmission, an automatic transmission, a manual gearbox, an electronically controlled gearbox or a continuously variable transmission (CVT).

Especially in the case of electric motors, however, designs are also conceivable that function without a gearbox andor a differential. Thus, for example, provision can be made such that the electric motor comprises two rotors controllable independently of one another and accommodated in the housing, said rotors each being assigned to one of the driving wheels. In order to enable a separated control, two electrical stators separated from one another are also required in the housing. Through a corresponding control of the two rotors independent of one another, the function of a differential transmission can be simulated electronically, as result of which further simplification and weight saving is achieved. The steering capabilities on a poor surface such as snow or ice are more wide-ranging than in the case of a standard differential.

The driven vehicle axle with the integrated engine is a semi-rigid axle or preferably an axle with a single-wheel suspension, wherein a steering-arm arrangement can in particular be a transverse steering arm in combination with a McPherson shock-absorbing leg, a double steering-arm unit or a multiple steering-arm unit with longitudinal and transverse steering arms. With regard to the selection of the steering-arm arrangement, no significant restrictions result from the embodiment according to the invention.

The subject-matter of the invention is also a passenger car module according to claim 11. During the assembly of the passenger car, the described passenger car module as a prefabricated unit is fastened via the housing to the body. Furthermore, the driving wheels themselves, i.e. the wheel rims with the tires fitted on, are then also fastened to the driving wheel supports. With regard to preferred embodiments of the passenger car module, reference is made to the above explanations in respect of the passenger car according to the invention.

The invention is explained below with the aid of a drawing merely representing an example of embodiment. In the figures:

FIG. 1 shows a driven rear axle of a passenger car,

FIG. 2 shows a front axle of a passenger car.

FIG. 1 shows a passenger car module in the form of a vehicle axle. The vehicle axle is fastened to a body of the passenger car, wherein the vehicle axle, in the example of embodiment a driven rear axle, comprises a central axle support 1 and two driving wheels attached laterally thereto in each case by means of a steering-arm arrangement 2 and driven by an engine 3 via in each case an articulated shaft 4. For the purpose of clarity, FIG. 1 represents only driving wheel supports 5 with a wheel hub and a brake disc, to which the driving wheels with their wheel rims and tires are bolted.

According to the invention, a housing 6 of the engine 3 is a transverse force-transmitting transverse bridge of axle support 1. Engine 3 with its housing 6 serves as a single element provided for the transmission of transverse forces, wherein steering arrangements 2 are each supported directly on the engine housing. It can also be seen that the entire passenger car module is bolted at housing 6 of engine 3 to the body, so that not only the transverse forces, but also all the longitudinal forces are supported via housing 6.

FIG. 2 shows a front axle of a passenger car. Within the scope of the invention, therefore, there is also the possibility of integrating a steering gear into a housing 106, which accommodates an engine 103 as a drive for a steering actuator and that can also contain a differential transmission or step-down gear unit.

According to FIG. 2, the fastening of axle support 1 also takes place via housing 106. In addition, a frame 7 with lateral longitudinal supports 8 and a rear transverse bridge 9 is provided for further reinforcement. The transverse forces are taken up both by housing 106 and transverse bridge 9. In the example of embodiment, apart from engine 103 as the drive for the steering actuator, an engine 3, which is provided for the drive of the wheels, is also disposed in housing 106.

With the aid of the drive energy of engine 103 for the steering actuator, tie rods 100 are displaced in their longitudinal direction corresponding to the steering input of the driver of the vehicle, wherein wheel supports 105 are rotated into the desired position.

In accordance with the usual design, the passenger car module also comprises shock-absorbing legs 11 for supporting and damping the driving wheels on the body as well as a stabilizer 12.

1. A passenger car with a body, an engine and a vehicle axle, which comprises an axle support connected to the body and, on said axle support, two wheels attached laterally in a movable manner in each case by means of a connection arrangement, wherein the wheels are movable via the connection arrangement by means of the engine and wherein a housing of the engine comprises a transverse force-transmitting transverse bridge of the axle support, wherein the axle support is fastened to the body via the housing of the engine.

2. The passenger car according to claim 1, wherein the connection arrangement is constituted at least by a steering-arm arrangement, wherein wheels as driving wheels are driven in each case via an articulated shaft by the engine.

3. The passenger car according to claim 2, wherein the steering-arm arrangements are supported directly on the housing of the engine or on fastening elements attached to the engine.

4. The passenger car according to claim 2, wherein the steering-arm arrangement is constituted as a transverse steering-arm unit or as a multiple steering-arm unit.

5. The passenger car according to claim 1, wherein the connection arrangement is constituted at least by a tie rod arrangement, wherein the wheels are adjustable in their orientation via the tie rod arrangement by means of the engine.

6. The passenger car according to claim 1, wherein the vehicle axle is constituted by two lateral axle sections each assigned to a respective wheel and the engine, wherein the housing of the engine is being the sole transverse bridge between the lateral axle sections.

7. The passenger car according to claim 1, wherein the engine, in a plan view of the vehicle axle, lies along a connecting line between the two wheels and, as a transverse bridge, thus transmits the major part of the transverse forces acting on the axle support or all the transverse forces acting on the axle support.

8. The passenger car according to claim 1, wherein the engine is an electric motor.

9. The passenger car according to claim 8, wherein the electric motor comprises two rotors controllable independently of one another, accommodated in the housing, and each assigned to one of the wheels.

10. The passenger car according to claim 1, further comprising:
a differential and/or a gearbox in the housing.

11. The passenger car according to claim 1, wherein the vehicle axle is fastened to the underside of the body.

12. A passenger car module for a passenger car, the module comprising:
an axle support capable of being fastened to a body;
two wheel supports attached laterally in a movable manner to the axle support by a respective connection arrangement; and
a housing of an engine forming a transverse force-transmitting transverse bridge of the axle support, the axle supports each being movable via the respective connection arrangement by means of the engine, the axle support being equipped so as to be fastened to the body via the housing of the engine.
